(19) United States
(12) Patent Application Publication
(10) Pub. No.: US 2026/0309861 A1
(43) Pub. Date: Oct. 8, 2026

(54) OBJECT TRACKING SYSTEM AND METHOD CAPABLE OF STABLE POSITION ESTIMATION FOR OBJECT WHOSE SHAPE IS RECOGNIZED UNSTABLY BY RADAR SENSOR

(71) Applicants: HYUNDAI MOTOR COMPANY, Seoul (KR); Kia Corporation, Seoul (KR)

(72) Inventor: Won Je JANG, Gyeonggido (KR)

(21) Appl. No.: 19/371,157

(22) Filed: Oct. 28, 2025

(30) Foreign Application Priority Data
Apr. 2, 2025 (KR) 10-2025-0042964

(51) Int. Cl. G01S 13/72; G01S 13/58; G01S 13/89; G01S 13/931; G06T 7/277; G06T 7/73

(52) U.S. Cl. CPC G01S 13/72; G01S 13/589; G01S 13/89; G01S 13/931; G06T 7/277; G06T 7/73; G06T 2207/10044; G06T 2207/30261

(57) ABSTRACT

A system that recognizes an object through artificial intelligence (AI)-based processing and at least one autonomous driving sensor including at least one radar sensor, and a method thereof. Operations include generating at least one cluster having position information and a velocity vector, and generating cluster information corresponding to the at least one cluster by clustering the plurality of point data obtained from the at least one radar sensor, correcting horizontal position information by applying a moving average to the horizontal position information among the position information, and updating track information, which includes heading information of a track, by recalculating a horizontal velocity of the velocity vector based on the position information. which includes the corrected horizontal position information.

### CROSS-REFERENCE TO RELATED APPLICATION

Pursuant to 35 U.S.C. § 119(a), this application claims the benefit of an earlier filing date and right of priority to Korean Patent Application No. 10-2025-0042964, filed in the Korean Intellectual Property Office on Apr. 2, 2025, the entire contents of which are hereby incorporated by reference.

### TECHNICAL FIELD

The present disclosure relates to an artificial intelligence (AI)-based system and method for tracking an object using an autonomous driving sensor.

### BACKGROUND

As autonomous vehicles are developed and commercialized, the number of cases using various sensors and artificial intelligence (AI) technologies to support the autonomous driving functions of vehicles has increased. For example, research is ongoing into what objects exist in front of a moving vehicle, what the distance is between the object and the vehicle, and what algorithms the vehicle should use to respond to specific situations to ensure safety.

Accordingly, vehicle sensor technology has been more advanced, and high-performance sensors such as a light detection and ranging (LiDAR) that recognizes the surrounding environment using laser beams, a radio detection and ranging (radar) that uses radio waves, an ultrasonic sensor, a fisheye camera capable of photographing 360-degree images, a multifocal lens, and a global positioning systems (GPS), and the like have been installed in a vehicle.

By aggregating measurement results obtained from multiple sensors as described above, it has been possible to implement a so-called super sensor vehicle. In autonomous driving (or self-driving), the concept of a super sensor refers to a technology that aims to recognize the surrounding environment more accurately by combining measurements from various sensors rather than relying on individual sensors for the convenience and safety of driving. With the addition of information and communications technology (ICT) and cloud technology, the sensors required for autonomous driving and the AI algorithms related to them have been more sophisticated than ever before, not only targeting a single vehicle, but also remotely accumulating data from numerous vehicle units (fleet of vehicles) and training AI servers and databases to increase the confidence of vehicle sensor determination.

However, in autonomous driving technology using radar, the recognition shape of an object is unstable due to the reflection characteristics of a radar sensor.

### SUMMARY

According to one aspect of the present disclosure, a system uses artificial intelligence (AI)-based processing and at least one radar sensor to reliably recognize and estimate a position of an object in a surrounding environment from a plurality of point data input from the radar sensor. The operations may include generating at least one cluster having position information and a velocity vector and generating cluster information corresponding to the at least one cluster by clustering the plurality of point data input from the radar sensor, correcting horizontal position information by applying a moving average to the horizontal position information among the position information, and updating track information, which includes including heading information of a track, by recalculating a horizontal velocity of the velocity vector based on the position information including the corrected horizontal position information.

According to an implementation, the operations further include generating updated position information and an updated velocity vector by applying a two-dimensional Kalman filter to the position information and the velocity vector after updating all of the track information.

According to an implementation, a vertical velocity of the velocity vector may be used without correcting a measurement value by the radar sensor.

According to an implementation, vertical position information of the position information may be updated based on the vertical velocity obtained through the radar sensor.

According to an implementation, when a number of measurements accumulated by the radar sensor is equal to or greater than a threshold value, the moving average may include a plurality of moving average values obtained based on radar sensor measurement results, where the plurality of moving average values are generated by applying a plurality of moving averages whose input sizes are different from each other.

According to an implementation, a plurality of weighted moving average values may be obtained by applying different weights to each of the plurality of moving average values according to a change rate of a current track.

According to an implementation, when the change rate of the current track is equal to or less than a specified reference value, larger weights are assigned to moving average values generated by moving averages with larger input sizes, and smaller weights are assigned to moving average values generated by moving averages with smaller input sizes.

According to an implementation, when the change rate of the current track exceeds a specified reference value, smaller weights are assigned to moving average values generated by moving averages with larger input sizes, and larger weights are assigned to moving average values generated by moving averages with smaller input sizes.

According to an implementation, the change rate of the current track may include a numerical value representing a speed of at which a target object tracked by the radar sensor moves in a horizontal direction.

According to an implementation, the object may be considered not to be tracked by the radar sensor when a number of the plurality of moving averages is less than a specified number.

According to another aspect of the present disclosure, a method of recognizing and reliably estimating a position of an object in a surrounding environment based on detection point data obtained from at least one autonomous driving sensor including at least one radar sensor includes generating at least one cluster having position information and a velocity vector and generating cluster information corresponding to the at least one cluster by clustering the plurality of point data input from the radar sensor, correcting horizontal position information by applying a moving average to the horizontal position information among the position information, and updating track information, which includes heading information of a track, by recalculating a horizontal velocity of the velocity vector based on the position information including the corrected horizontal position information.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of an overall system for automatically recognizing an object and controlling a vehicle for the purpose of autonomous driving or the like according to an implementation of the present disclosure;

FIG. 2 is a flowchart illustrating an example of the entire algorithm related to radar signal processing (RSP) according to an implementation of the present disclosure;

FIG. 3 is a flowchart generally illustrating an example of an algorithm that enables estimating and tracking a stable position for an object whose shape is unstable as observed by a radar sensor according to an implementation of the present disclosure;

FIG. 4 is a diagram illustrating an example of the relationship between the result of generating cluster position information and ground truth (GT);

FIG. 5 is a diagram illustrating example experimental results including vertical velocity estimation results and horizontal velocity estimation results of a radar sensor;

FIG. 6 is a diagram illustrating a first example of a process of correcting a horizontal position error based on a moving average according to an implementation of the present disclosure;

FIG. 7 is a diagram illustrating a second example of the process of correcting a horizontal position error based on a moving average according to an implementation of the present disclosure

FIG. 8 is a flowchart illustrating an example of an operation of measuring a track change rate in a process of correcting a horizontal position error based on a moving average according to an implementation of the present disclosure;

FIG. 9 is a diagram illustrating an example of the physical meaning of a difference in the input size of a moving average in a process of correcting a horizontal position error based on a moving average according to an implementation of the present disclosure;

FIG. 10 is a diagram illustrating an example experimental result to which a process for correcting a horizontal position error based on a moving average is applied according to an implementation of the present disclosure; and

FIG. 11 is a block diagram illustrating an example of a computing system for autonomous vehicle control and object recognition operations according to an implementation of the present disclosure.

### DETAILED DESCRIPTION

Implementations of the present disclosure provide a system and method for tracking an object by using artificial intelligence (AI) and autonomous driving sensors. In some implementations, an object tracking system and method are provided that can estimate the position of an object based on measurements that have unstable shapes, as detected by autonomous driving sensors, e.g., a radar sensor.

In some implementations, the technology is capable of stably estimating a position and correcting a velocity even when the shape of a radar observation object is unstable.

By comparison, LiDAR data-based technology is typically able to infer a position by selecting a representative point of a box, because the accuracy of the shape is relatively accurate. However, with other sensors such as radar sensors, the shape of an object observed by the radar is very unstable, even when a representative point of a box is selected, and a very large position error can occur., As such, there is a need to develop processing logic to correct the error. In some scenarios, the processing logic for estimating the representative position of an object based on the box shape can assume that the box is able to represent the entire shape of the object. However, because the shape of an object observed by the radar is often very unstable, even when the representative point of the box is selected, the position error can be very large.

Implementations of the present disclosure can provide a technology for estimating the exact position of an object even when the shape information of the observed object changes significantly, and further proposes a technology for estimating the exact horizontal velocity and heading by recalculating the unstable horizontal velocity detection performance of a radar sensor based on the position information of the object.

As such, according to implementations of the present disclosure, a stable position can be estimated based on an observation result whose shape is very unstable, and information including velocity vector information and shape information of an object, e.g., as received as input using radar observation data, can be used to generate stable position information of the object. In addition, in scenarios where radar observation data results in the shape of the object being very unstable but the confidence of the vertical velocity being high, the vertical velocity and position estimation values cam be updated using the radar observation values, while the horizontal velocity and horizontal position are calculated by the techniques according to implementations of the present disclosure.

Furthermore, according to implementations of the present disclosure, the object position can be further estimated through processing logic operations, e.g., using a 3-step processing logic, to eliminate horizontal position error, and a new horizontal position correction technique using a moving average value is described herein to enable stable position estimation.

In addition, through the detailed description of the present disclosure and the attached drawings, those skilled in the art will be able to understand various effects other than the effects described above from the present disclosure.

Hereinafter, some implementations of the present disclosure will be described in detail with reference to the exemplary drawings. In adding the reference numerals to the components of each drawing, it should be noted that the identical or equivalent component is specified by the identical numeral even when they are displayed on other drawings. Further, in describing the implementation of the present disclosure, a detailed description of the related known configuration or function will be omitted when it is determined that it interferes with the understanding of the implementation of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. For example, in the present disclosure, an object has virtually the same meaning as an object, and the expressions “object” and “subject” are arbitrarily used interchangeably in the present disclosure.

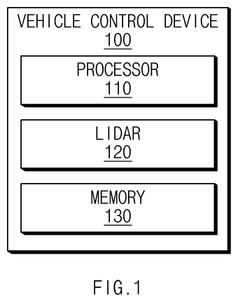

FIG. 1 is a block diagram illustrating an example of an overall system for automatically recognizing an object and controlling a vehicle for the purpose of autonomous driving or the like according to an implementation of the present disclosure.

Referring to FIG. 1, a vehicle control device 100 according to an implementation of the present disclosure may be implemented inside or outside a vehicle, and some of the components included in the vehicle control device 100 may be implemented inside or outside the vehicle. For example, the vehicle control device 100 may be formed integrally with the internal control units of the vehicle, or may be implemented as a separate device and connected to the control units of the vehicle by a separate connection technique. For example, the vehicle control device 100 may further include components not shown in FIG. 1.

The vehicle control device 100 according to an implementation may include a processor 110, a sensor 120 such as a LiDAR (Light Detection And Ranging) sensor, and a memory 130. The processor 110, the sensor 120, or the memory 130 may be electronically and/or operably coupled with each other by an electronic component such as a communication bus.

Hereinafter, hardware being operably coupled may mean that a direct connection or an indirect connection between the hardware is established wired or wirelessly, such that second hardware is controlled by first hardware among the hardware.

Although illustrated in different blocks in FIG. 1, implementations are not limited thereto, and some of the hardware in FIG. 1 may be included in a single integrated circuit such as a system on chip (SoC). The type and/or number of hardware included in the vehicle control device 100 is not limited to that illustrated in FIG. 1. For example, the vehicle control device 100 may include only some of the hardware illustrated in FIG. 1.

The vehicle control device 100 according to an implementation may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), a graphic processing unit (GPU), and/or an application processor (AP). The processor 110 may have a single-core processor structure, or may have the structure of a multi-core processor including dual cores, quad cores, hexa cores, or octa cores.

According to an implementation, the processor 110 may include at least one of a graphic processing unit (GPU), a neural processing unit (NPU), or any combination thereof. For example, a GPU may be referred to as a visual processing unit (VPU). For example, an NPU may be referred to as a neural network processing unit.

The vehicle control device 100 according to an implementation may include a sensor 120, such as a depth sensor, for detecting an external object. For example, a depth sensor for detecting an external object may include at least one of a time-of-flight (ToF) sensor, a LiDAR sensor, a structured light sensor, an ultrasonic sensor, an infrared sensor, a radio detection and ranging (radar), an optical distance sensor, or any combination thereof. Hereinafter, for convenience of explanation, the description will focus on the LiDAR, but implementations are not limited thereto.

The vehicle control device 100 according to an implementation may include the LiDAR sensor 120 (or simply referred to as LiDAR 120) that obtains a plurality of points based on a pulse laser signal. For example, the LiDAR 120 can obtain data sets that identify objects surrounding the vehicle control device 100 (or a vehicle including the vehicle control device 100). For example, the LiDAR 120 may identify at least one of the position, direction of movement, speed, or any combination thereof of surrounding objects based on the pulse laser signal emitted from the LiDAR 120 being reflected back from surrounding objects.

For example, the LiDAR 120 may obtain data sets representing external objects in the space formed by the x-axis, the y-axis, and the z-axis based on pulse laser signals reflected from surrounding objects. For example, the LiDAR 120 may obtain data sets including a plurality of points in the space formed by the x-axis, the y-axis, and the z-axis based on receiving a pulse laser signal every specified time period. For example, the plurality of points may include points representing external objects within a three-dimensional virtual coordinate system. The 3D virtual coordinate system may include at least one of a vehicle coordinate system, a LiDAR coordinate system, or any combination thereof. However, examples of the 3D virtual coordinate system are not limited to those described above.

The memory 130 of the vehicle control device 100 according to an implementation may include a hardware component for storing data and/or instructions input and/or output to the processor 110. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

In the memory 130 of the vehicle control device 100, one or more instructions (or commands) indicating calculation and/or operations to be performed by the processor 110 of the vehicle control device 100 with data may be stored. A set of one or more instructions may be referred to as a program, firmware, an operating system, a process, a routine, a sub-routine, and/or an application.

Hereinafter, the fact that an application is installed in the vehicle control device 100 may mean that one or more instructions provided in the form of an application are stored in the memory 130, and that one or more applications are stored in a format executable by the processor 110 of the vehicle control device 100 (e.g., a file having an extension specified by an operating system of the vehicle control device 100).

For example, the memory 130 may include a first neural network model for detecting an object. For example, the memory 130 may include a second neural network model for outputting the types of the plurality of points obtained by the LiDAR 120 and/or the scores of the plurality of points.

In an implementation, the processor 110 may obtain at least one of a first virtual box representing a target object, a first class representing a type of the target object, or a combination thereof, based on the plurality of points obtained through the LiDAR 120 and the first neural network model stored in the memory 130.

For example, the processor 110 may obtain at least one of a first virtual box representing a target object, a first class representing a type of the target object, or any combination thereof, based on inputting the plurality of points into the first neural network model. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is tracked, e.g., continuously tracked. For example, the type of a target object may be one or more of multiple types for classifying the target object. For example, the type of the target object may include at least one of a first type representing the ground, a second type representing a type different from the ground, or any combination thereof. However, the type of a target object is not limited to the above. For example, the type of a target object may include, at least one of a third type representing a person, a fourth type representing a vehicle, or any combination thereof, but is not limited thereto.

In an implementation, the processor 110 may obtain, based on the plurality of points and the second neural network model, at least one of first partial points corresponding to at least a part of the target object among the plurality of points, a second class identified through the first partial points and indicating the type of the target object, or any combination thereof. For example, the second neural network model may include a segmentation model.

For example, the second neural network model may include a neural network model for obtaining types of the plurality of points and scores of the plurality of points.

For example, the processor 110 may obtain first partial points corresponding to at least a portion of the target object among the plurality of points based on inputting the plurality of points into the second neural network model. For example, the processor 110 may identify the types of the plurality of points based on inputting the plurality of points into the second neural network model. For example, the processor 110 may obtain the first partial points corresponding to at least a portion of the target object from among the plurality of points based on the type of each of the plurality of points.

In an implementation, the processor 110 may perform a first specified algorithm for a plurality of points. For example, the processor 110 may perform the first specified algorithm for classifying a type of each of the plurality of points for a plurality of points. For example, the processor 110 may classify second partial points corresponding to a specified type among the plurality of points. For example, the specified type may include a type representing the ground.

For example, the processor 110 may classify the second partial points corresponding to a specified type based on performing the first specified algorithm on the plurality of points, and obtain (or identify) the first partial points by excluding the second partial points from among the plurality of points.

In an implementation, the processor 110 may obtain at least one of a partial class for obtaining a second class, a score of each of the plurality of points, or any combination thereof, based on inputting the plurality of points into the second neural network model. For example, the processor 110 may obtain a partial class and a score for each of the plurality of points based on inputting the plurality of points into the second neural network model. For example, the partial class may include a classification of each of the plurality of points into an arbitrary type.

For example, the processor 110 may fuse the partial class, the score of each of the plurality of points, and the second partial points. For example, the processor 110 may perform clustering based on the fusion of the partial class, the score of each of the plurality of points, and the second partial points. For example, clustering may include grouping the first partial points that correspond to at least part of a target object.

For example, the processor 110 may obtain a point cloud for generating a second virtual box based on the first partial points. For example, the processor 110 may obtain the point cloud based on grouping the first partial points.

For example, the processor 110 may generate a second virtual box for representing the target object, which is different from the first virtual box, based on the point cloud. For example, the second virtual box may include a box that includes at least some of the first partial points.

For example, the processor 110 may identify a heading direction indicating the moving direction of the target object based on at least one of the first partial points, the point cloud, or any combination thereof.

For example, the processor 110 may identify the position of the second virtual box in a virtual coordinate system based on at least one of the first partial points, the point cloud, or any combination thereof. For example, the processor 110 may identify the size of the second virtual box based on at least one of the first partial points, the point cloud, or any combination thereof. For example, the processor 110 may identify the second class based on at least one of the first partial points, the point cloud, or any combination thereof. For example, the processor 110 may identify at least one of the heading direction indicating the moving direction of a target object, the position of the second virtual box in the virtual coordinate system, the size of the second virtual box, the second class, or any combination thereof, based on at least one of the first partial points, the point cloud, or any combination thereof. For example, the processor 110 may identify the heading direction of the bounding box based on at least one of the first virtual box, the first class, the heading direction of the second virtual box, the position of the second virtual box, the size of the second virtual box, the second class, or any combination thereof. For example, the processor 110 may identify the position of the bounding box in the virtual coordinate system based on at least one of the first virtual box, the first class, the heading direction of the second virtual box, the position of the second virtual box, the size of the second virtual box, the second class, or any combination thereof. For example, the processor 110 may obtain a third class indicating the type of a target object corresponding to the bounding box based on at least one of the first virtual box, the first class, the heading direction of the second virtual box, the position of the second virtual box, the size of the second virtual box, the second class, or any combination thereof. For example, the processor 110 may obtain at least one of the heading direction of the bounding box, the position of the bounding box in the virtual coordinate system, the third class indicating the type of a target object corresponding to the bounding box, or any combination thereof, based on at least one of the first virtual box, the first class, the heading direction of the second virtual box, the position of the second virtual box, the size of the second virtual box, the second class, or any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box by using the second identifier. For example, the processor 110 may track a target object based on identifying a plurality of bounding boxes including the bounding box to which the second identifier is assigned, in a plurality of frames. For example, in scenarios where the second identifier is an identifier assigned to the bounding box corresponding to the target object, the processor 110 can track the target object by identifying the plurality of bounding boxes to which the second identifier is assigned, in the plurality of frames.

In an implementation, the processor 110 can output the bounding box corresponding to the target object based on at least one of the first virtual box, the first class, the first partial points, the second class, or any combination thereof. For example, the bounding box may include an example of a target object represented in the virtual coordinate system in the form of a hexahedron.

Hereinafter, operations performed by a CPU, a GPU, and/or an NPU included in the processor 110 will be briefly described.

In an implementation, the processor 110 may include at least one of a CPU, a GPU, an NPU, or any combination thereof. For example, at least one of the GPU, the NPU, or any combination thereof may obtain the first virtual box and the first class based on the first neural network model. For example, at least one of the GPU and the NPU may obtain the first virtual box and the first class. For example, at least one of the GPU, the NPU, or any combination thereof may obtain the partial class for obtaining the second class and the score for each of the plurality of points based on the second neural network model. For example, at least one of the GPU and the NPU may obtain the partial class for obtaining the second class and the score for each of the plurality of points based on the second neural network model. For example, the CPU may classify second partial points among the plurality of points that correspond to a specified type, based on performing the first specified algorithm for classifying the type of each of the plurality of points for the plurality of points.

As described above, the vehicle control device 100 according to an implementation may include at least one processor 110. The vehicle control device 100 may accurately detect a target object by detecting the target object using at least one processor 110. In addition, by performing parallel processes, the vehicle control device 100 may reduce the load on each processor.

Object recognition is described next, including examples based on specific scenarios. Specifically, to describe the general concept of AI-based object recognition, a description is provided for a scenario of LiDAR-based object recognition.

In some implementations, an object recognition process by LiDAR 120 and AI module includes three operations: preprocessing, segmentation, and tracking.

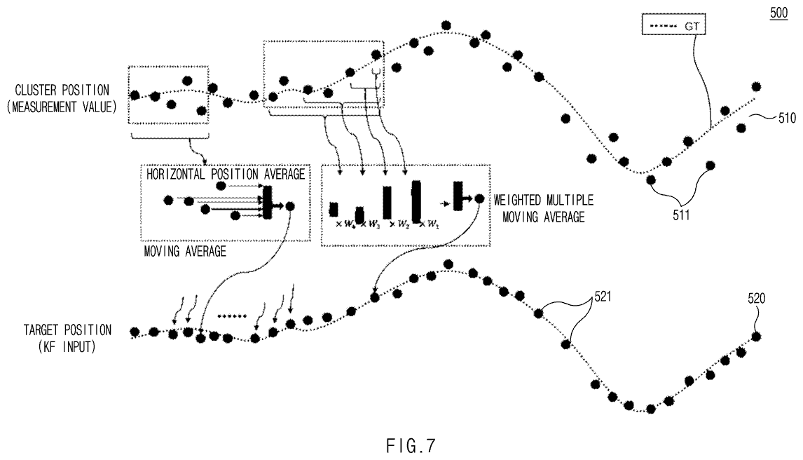

Pre-processing can be performed by the object recognition system 1000 (e.g., see FIG. 7), before executing an object recognition function. The preprocessing may include, for example, an operation of removing points forming the ground based on laser sensing data (i.e., unprocessed raw data) input from LiDAR 120. Because a laser beam reflected from the ground could be mistakenly recognized as an object on the ground, the process of distinguishing between the ground and non-ground can be performed in a preprocessing operation, and in some scenarios, can ay also be performed in a segmentation operation.

In some implementations, preprocessing in AI object recognition can include a process in which an image processing tool of an AI module in the processor 110 removes noise from a LiDAR point cloud image and reduces the total number of points existing in the LiDAR point cloud image through, for example, a voxel down-sampling technique to improve computational efficiency.

For reference, the LiDAR point cloud image may also be displayed in a bird's eye view (BEV) manner. When a LiDAR map is created as if it was a bird's eye view of the city while flying in the sky, it is called a BEV image.

For example, as described above, the LiDAR 120 transmits a laser beam into a surrounding environment and records the round-trip time during which the laser beam is reflected by an external object and returns, thereby generating a dot (i.e., a point) for each of numerous laser signals, based on which the distance to the point can be calculated. By repeatedly transmitting a large number of laser beams in such a manner, the processor 110 can generate a real-time LiDAR map of the surrounding environment as a BEV type three-dimensional map, and as a two-dimensional map in some scenarios.

The lines or surfaces that appear in black and white on the LiDAR point cloud map can be composed of a large number of points (e.g., each of which is generated by a laser beam of the LiDAR 120), and for this reason, the LiDAR sensing image is also called a LiDAR point cloud image. In some implementations, by combining a red-green-blue-depth (RGB-D) sensor with a LiDAR sensor, the LiDAR point cloud image may be reconstructed in color.

Although it can be difficult for humans to recognize objects with just one point in a LiDAR point cloud image, when a human observer looks at the point cloud comprehensively, such as from a BEV perspective or a two-dimensional plan, the human observer can obtain an approximate understanding of what the surroundings of the vehicle currently driving autonomously look like. Furthermore, it is possible to recognize, for example, vehicles, buses, pedestrians, street trees, traffic signs, etc. existing in a LiDAR point cloud image. In AI image recognition technology, things or people may be called objects, and each object may be classified into a class that belongs to a group with specific characteristics, such as a vehicle class, a bus class, and the like.

In some implementations, machine learning such as those involving a deep AI neural network can be implemented to classify objects within a LiDAR point cloud image into car and bus classes and the like. In some cases, AI training can be performed, e.g., as a precedent step, before deploying the AI neural network to find objects in a LiDAR point cloud image and identify the classes of those objects using an AI neural network.

For example, a dataset called PANDASET™ (source: https://pandaset.org/#data-collection) includes over 48,000 camera images (mostly taken in the Silicon Valley area in the United States) and over 16,000 LiDAR scan images, which are annotated with 28 classes in total, including pedestrians, vehicles, bicycles, construction site signs, traffic signs, and the like.

In addition, a LiDAR point cloud image may be visualized to suit the user's desired options by using a point cloud processing tool such as Open3D™ (source: https://www.open3d.org/). Because the LiDAR 120 is capable of distance detection, a 3D LiDAR image may be reproduced more realistically, for example, by displaying distant objects in dark blue and nearby objects in light blue during visual processing with Open3D™.

In addition, as described above, in some implementations the original LiDAR image (i.e., raw data) may be preprocessed, for example, by applying a technique called voxel (3D pixel) down-sampling to the LiDAR point cloud image. In this case, a voxel refers to a 3D pixel in the shape of a cube, and voxel down-sampling is a technology that reduces the number of points so as not to require excessive AI calculations while maintaining the structure of various objects included in a LiDAR point cloud.

In some implementations, the LiDAR 120 emits, for example, “m” laser beams “n” times during one scan cycle, and in this case, the scan values of the laser beams that return after reflecting off an external object can be represented as an (m×n) matrix, and (m×n) matrix data is called a range image. Each point that constitutes a LiDAR point cloud image can include, for example, depth (i.e. range) information, as well as the intensity, azimuth, inclination, and other additional information of the reflected laser pulse. As an example, for a range image, AI learning is possible with large datasets such as Waymo™ open dataset (WOD).

Range view (RV) is a technique that converts a 3D point cloud into a 2D or 2.5D scene, and expresses it as a LiDAR 3D map that humans intuitively understand, like an analog picture, instead of a large number of points. In a range view image, a 3D LiDAR point cloud image has 2D coordinates, but the 3D laser-related information (angle, inclination, intensity, etc.) recorded when obtaining the range image is not discarded. By applying a variable called a width to (x, y) coordinates among the (x, y, z) coordinate values of a 3D LiDAR image, the coordinate of one 2D axis is obtained, and by applying a variable called a height and range image information representing the range (depth) to the (z) coordinate, the coordinate of another 2D axis is obtained, which creates a 2D range view image.

In addition, an AI algorithm according to implementations of the present disclosure can include a convolutional neural network (CNN), which can be trained e.g., by an AI training module to extract features (or feature points) from image data. For example, the training can utilize datasets including tens of thousands of images, and the CNN can be capable of processing images from one dimension to three dimensions. As such, the results of the range view image processing tool can be used to train a CNN neural network and perform the function of helping AI accurately recognize objects in an image.

In scenarios where objects around an autonomous vehicle are recognized through machine learning, an operation of generating a ground truth (GT) bounding box on the LiDAR map described above can be implemented as part of object recognition. In machine learning, ground truth (GT) is a term used to indicate an original or actual value of data that an AI is to learn. For example, the GT can be viewed as a type of image annotation applied to a LiDAR point cloud image, usually as a bounding box with a box-shaped boundary.

For example, to perform recognition of objects, the AI module can determine labels and group various objects. In some scenarios, the spacing of the 3D data points that are used to output the GT bounding box can be configured to allow, for example, approximately 50 and 1000 LiDAR cloud points to be contained in one GT bounding box.

In some scenarios, such GT annotations do not exist in the raw data captured by sensors such as LiDAR 120 and the like while the vehicle drives. The processor 110 can recognize objects belonging to various classes, such as road signs, crosswalks, pedestrians, other vehicles, and center lanes, as objects. GT annotation can be used to measure an object recognition error and, in some implementations, evaluate AI performance by comparing object determination results recognized by the AI algorithm of the processor 110 with reality. The GT bounding box can be applied to the original image in the form of annotations, which can be set manually by the user, or can be set through GT calculation tools, such as Grid-striding.

AI object recognition can also utilize predicted bounding boxes. A predicted bounding box can represent a result recognized by the processor 110 as an object of a specific class from the original image data obtained from the LiDAR 120, and the like. The predicted bounding box can be represented in the form of another bounding box similar to the GT bounding box. However, unlike GT bounding boxes, predicted bounding boxes are the result of computations by the autonomous driving AI. The predicted bounding box may coincide with the GT bounding box, but the predicted bounding box may not coincide with the GT bounding box or may not overlap with the GT bounding box at all.

For reference, because it can be difficult to definitively determine that a specific class of object actually exists at a specific location based on predicted bounding boxes alone, the predicted bounding boxes are usually called probability boxes (P-Boxes).

Segmentation processing can be performed after preprocessing. Segmentation processing can, for example, result in displaying a specific part of a road (e.g., a traffic light) with a particular annotation (e.g., in color red) and the other parts (asphalt road) with another annotation (e.g., in color blue). Segmentation can involve clustering point clouds into specified groups and generating P-Boxes. In some implementations, cluster expansion can be performed, where the expansion target includes the cluster that is expanded to include all points within a given distance from the seed point plus an additional incremental distance epsilon (where the given distance constitutes the unexpanded cluster).

In some implementations, clustering and P-box generation based on a point cloud can be performed during segmentation processing. For example, an AI network performing segmentation can be used to obtain point labels from data collected by sensors, such as the LiDAR 120.

Implementations of the present disclosure can utilize a “rule-based” ground recognition and label fusion technique, which can help address problems of ground recognition errors occurring during segmentation. Such a road surface recognition algorithm can apply any of a variety of techniques, including slope-based road surface recognition, grid-based road surface recognition, and other non-planar-based road surface recognition. Implementations of the present disclosure are described based on a slope-based road surface recognition technique when recognizing the road surface inside a tunnel.

For reference, semantic segmentation can involve attaching a unique class label to each point in the point cloud generated by the LiDAR 120. In LiDAR image processing technology, semantic segmentation can find and use meaningful information from LiDAR data for object recognition and scene reproduction for implementing autonomous driving. Various semantic segmentation AI models can be used, such as a projection-based method, a point-based method, a sparse convolution-based method, and the like. For example, the semantic segmentation result can be the result of an AI operation performed by the processor 110 with the NVIDIA DRIVE™ AGX system, and through such a configuration, for example, various colors may be added to a LiDAR point cloud image.

After performing a segmentation process as described above, in some implementations, LiDAR images can be further processed through post-processing. Post-processing can involve converting point cloud data into 3D maps or modeling, which can be meaningful information for autonomous driving. Post-processing can also include, in some scenarios, removing noise and errors from LiDAR point cloud images, recognizing objects such as vehicles or pedestrians from the point cloud, and, in some scenarios, attaching a unique identifier to the point cloud information to register it.

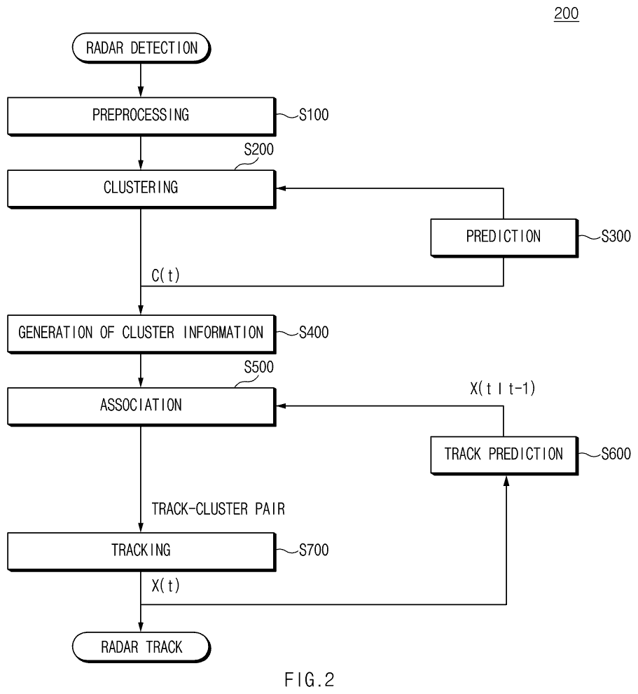

FIG. 2 is a flowchart illustrating an example of the entire algorithm related to radar signal processing (RSP) according to an implementation of the present disclosure.

Referring to FIG. 2, in operation S100, the detected data is input from the radar sensor, and the processor 110 (e.g., including an AI module) according to implementations of the present disclosure and the computing system 1000 perform a preprocessing process.

In some scenarios, the preprocessing process of operation S100 is identical to the preprocessing process described above. For example, operation S100 can include processing detection point data received from each of multiple radars (e.g., five radars) appropriately placed around the vehicle, for example. In some implementations, if the data is in different radar sensor coordinate systems, then the data can be processed to be transformed into a single data format of the coordinate system of the host vehicle equipped with the radar sensor(s). In some scenarios, radar detection points may contain a lot of noise. As such, in some implementations, noise filtering can also be performed in operation S100, e.g., using signal information provided from the radar sensor and data information around the detection point.

In operation S200 of FIG. 2, a clustering process is performed. Clustering can provide numerous technical benefits, for example, by reducing the AI calculation time for object tracking using radar, through clustering of detection points from which noise was removed in operation S100.

In some implementations, point cloud clustering can be performed by using both velocity information (e.g., using the radio and Doppler principle) and position information by utilizing the characteristics of a sensor such as radar. In some scenarios, points that are not clustered can be filtered out as invalid detection points.

In operation S300, prediction can be performed. For example, a procedure can be performed in which an object detection (OD) network (e.g., included in an AI module) according to implementations of the present disclosure predicts an object based on the clustering result that was generated in operation S200. For example, the P-Box described above can be generated in operation S300. In such scenarios, in subsequent operation S400, the P-Box information generated in operation S300 can be utilized.

In operation S400, cluster information is generated. The cluster information can include, for example, vertical speed, horizontal speed, heading direction, location, cluster box information, and the like. In some scenarios, due to the characteristics of the radar sensor, detection points included in each cluster have Doppler information, and it is possible to analyze it to generate a representative velocity vector in operation S400. In addition, in operation S400, representative location and box information of a cluster can be generated using position information of detection points included in the cluster.

In operation S500, an association is performed between clusters and tracks. For example, the association operation can be performed between (i) the track predicted at a current time point based on data updated up to the previous time point and (ii) the newly observed cluster at the current time point. The track can be predicted by predicting the location at the current time point (e.g., through the track preprocessing process) using the location and velocity information at the previous time point.

In operation S600, the track prediction is performed. In this case, the predicted track information can include track position, track box shape, track velocity, track heading, age, confidence, and the like. The track prediction X(t|t-1) is a prediction of the track at current time t based on information collected up to previous time t-1. For example, a state transition model can be used to generate the prediction X(t|t-1) from X(t-1) using previously collected cluster information up to time t-1, such as speed, heading, and position information.

In operation S700, a tracking result is generated. For example, the track information can be updated using new cluster information at the current time for C(t) that has been associated with the predicted track X(t|t-1). For example, this process can use a Kalman filtering update to generate a track that is updated to current time t using information collected up to current time t. For example, the updated track information can include track position, track box shape, track velocity, track heading, age, confidence, and the like as described above. Further details of the tracking operation in S700 are described below, with reference to various examples of implementations of the present disclosure.

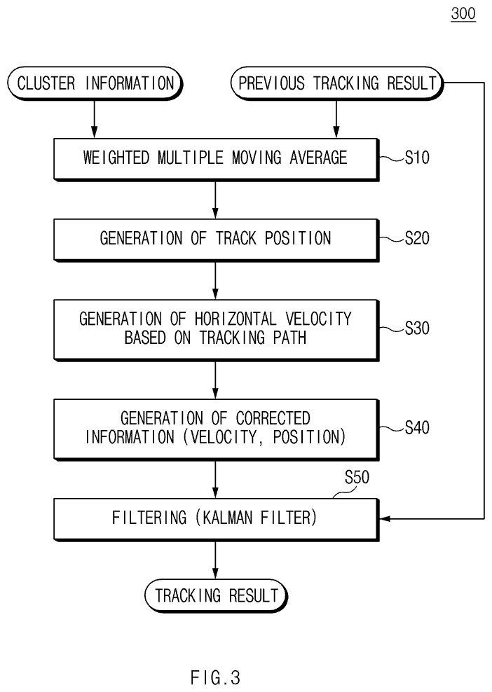

FIG. 3 is a flowchart generally illustrating an example of an algorithm 300 that enables estimating and tracking a stable position for an object whose shape is unstable as observed by a radar sensor according to an implementation of the present disclosure. For example, the algorithm 300 illustrated in FIG. 3 can be used to obtain stable position information from radar observation results whose shape is very unstable. In some implementations, the algorithm 300 can be implemented to perform the tracking operation in S700 of FIG. 2.

Before describing FIG. 3, it should be noted that there can be various causes of an unstable observation result For example, in the scenario of radar observations, unlike LiDAR sensors, there can arise problems where radar data may not be accurately reflected from the outline of the object. For example, the radar signal may be reflected irregularly, in which case clusters may be divided during the clustering process, and only a very small number of radar measurement points may be obtained. In this case, even if clustering and shape generation are performed, there is a very high probability that horizontal and vertical position errors will occur.

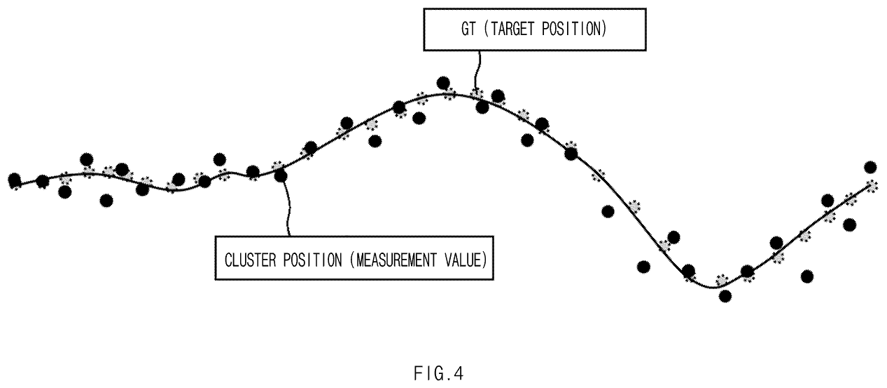

In the description of FIG. 3 below, the different operations of FIG. 3 will be described in conjunction with intermittent references to FIG. 4 to FIG. 9 as appropriate to describe further details of each operation illustrated in FIG. 3.

In the example of FIG. 3, cluster information can be one of the inputs and can include a position and velocity vector. In some scenarios of radar observations, the vertical component of the velocity vector (x, y) may be measured very accurately, but the horizontal component of velocity may be quite inaccurate. The position (x, y) coordinates can have large positional errors in the horizontal and vertical directions depending on a size of cluster distribution. To mitigate such problems, the position information can be corrected and horizontal speed correction can be performed using the horizontal position displacement difference.

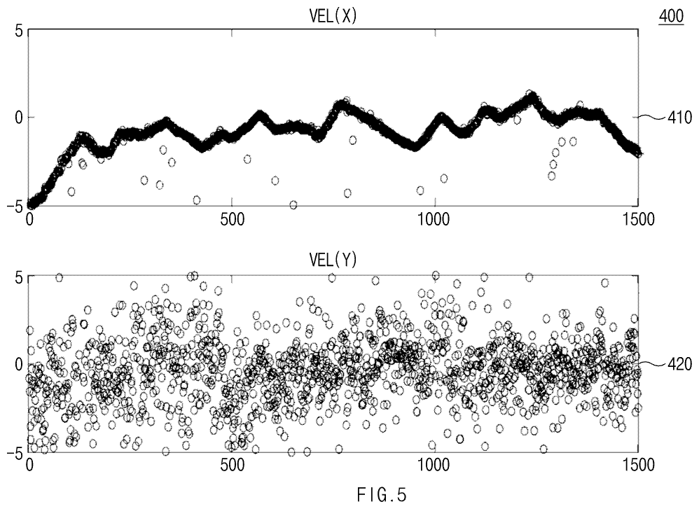

FIG. 4 is a diagram illustrating an example of the relationship between the result of generating cluster position information and ground truth (GT). The cluster position information (e.g., the measurement value) can deviate to some extent from the target location GT and the curve connecting it. For example, FIG. 5 is a diagram illustrating experimental results 400 including vertical velocity estimation results 410 and horizontal velocity estimation results 420 of a radar sensor.

Referring back to FIG. 3, in operation S10, cluster information and previous tracking results as described above can be obtained (e.g., input into an AI module). In operation S10, a weighted multi-moving average can be calculated.

In some implementations, the moving average (MA) can be used for position correction. For example, in the case of vertical position, in scenarios where the vertical velocity value observed by the radar is accurate, it is possible to update the vertical position by using the observed result as is. In such scenarios, in operation S10, only the horizontal position is used to calculate the correction value for the horizontal position using the moving average technique. In some implementations, the input size of the moving average can be adaptively changed, e.g., can be determined according to the track age (e.g., the size of the moving average window can be up to 10, in scenarios where the track age is at least 10).

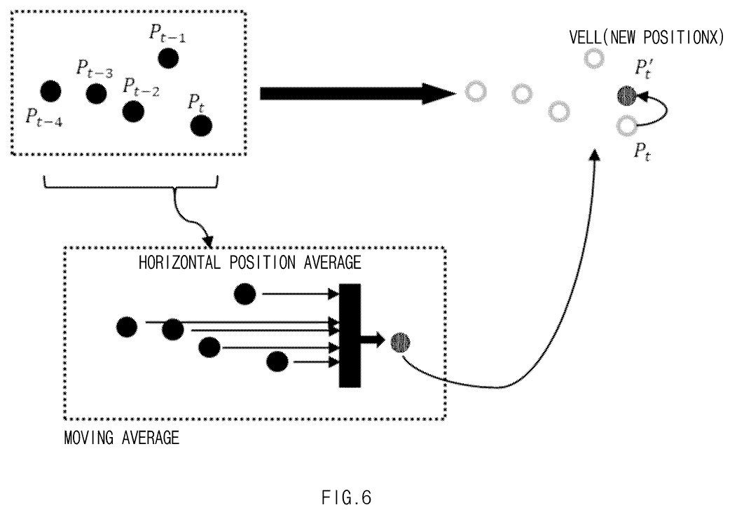

FIG. 6 is a diagram illustrating a first example of a process of correcting a horizontal position error based on a moving average according to an implementation of the present disclosure. As shown in the example of FIG. 6, radar observation position Pₜ at the current time point is corrected to P′ₜ on the basis of the average obtained by summing the observation results back to a previous time point t-4, i.e., the moving average window includes time points t, (t-1), (t-2), (t-3), (t-4) in the example of FIG. 6.

FIG. 7 is a diagram illustrating a second example of a process 500 of correcting a horizontal position error based on a moving average according to an implementation of the present disclosure. In this example, FIG. 7 illustrates a process of applying a weighted multiple moving average in operation S10 in FIG. 3.

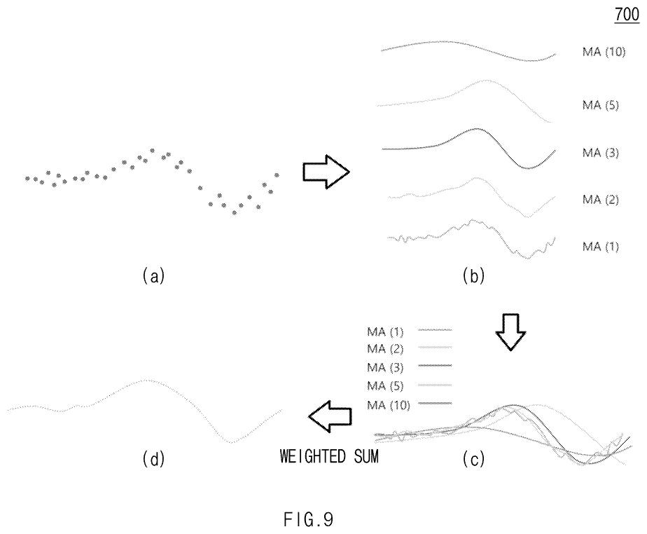

As illustrated in FIG. 7, for tracks with sufficiently accumulated ages, moving average MA values of various sizes may be obtained. In the example of FIG. 7, the upper left hand box shows a single MA value obtained using 5 inputs. The box to the right thereof shows multiple MA values obtained. In this example, four different MA values are obtained using 6 inputs, 4 inputs, 2 inputs, and 1 input (each denoted by different brackets in the box). Based on these various moving average values (each of which can obtain the MA using different numbers of input points), the final horizontal position correction can be performed by taking a weighted average of the different MA values, e.g., by applying different weights to the different MA values. In some implementations, the update rate can be adjusted, for example, by adjusting the weights of the different moving average values according to the change rate of the current track. Further details of adjusting the update rate are explained with reference to FIG. 9.

In FIG. 7, reference number 510 indicates a cluster position, e.g., a radar measurement result, and reference number 511 indicates each of position information according to the radar measurement result 510. Reference number 520 represents the most recent estimated target position, which can be used to generate an input to the Kalman filter to generate an estimated target position at the next time point. Reference number 521 represents past estimates of the target positions, which are the corrected result of position information such as 511. The dotted line represents a GT reference point. According to implementations of the present disclosure, instead of using only the most recent measurement point (in the measurement cluster 510) to perform the Kalman filtering update, different MA results using different numbers of past measurement points in 510 are obtained, and a weighted average of those different MA results is generated, and the weighted average is used as the new measurement result. This new measurement result can then be used, in conjunction with the previous estimated target position, in the Kalman filtering update. By appropriately adjusting the sizes of the different MA operations and/or by adjusting the weights assigned to the different MA results, a more stable and accurate tracking result can be obtained.

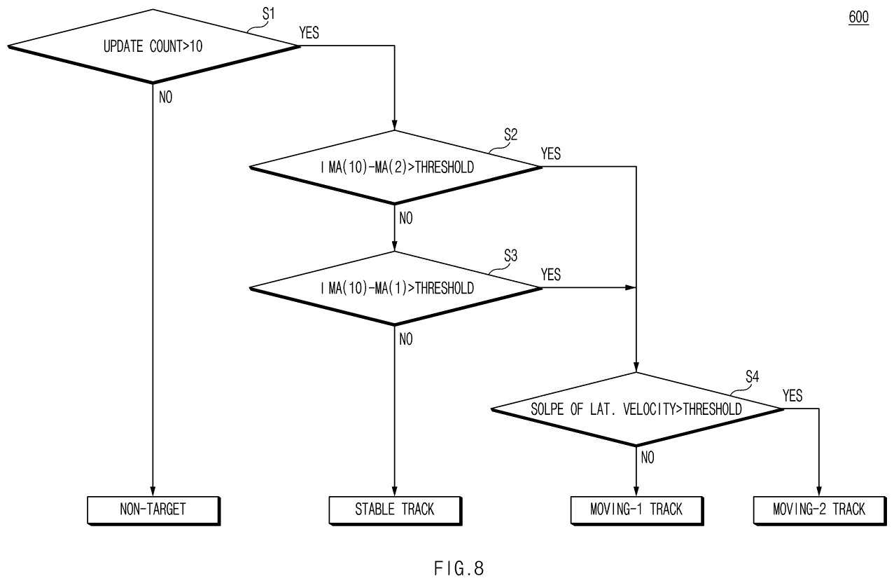

FIG. 8 is a flowchart 600 illustrating an example of an operation of measuring a track change rate in a process of correcting a horizontal position error based on a moving average according to an implementation of the present disclosure. The change rate of the current track can be a numerical value indicating how quickly the track's lateral position is changing. The measured lateral change rate can then be used to determine appropriate sizes of the different MA operations and/or appropriate weights assigned to the different MA results to yield accurate and stable tracking.

In the example of FIG. 8, operation S1 is a procedure for determining whether a target is detected, e.g., based on the point count exceeding 10. If a target is detected, then a determination is made as to whether changes in horizontal movement are large or small. In some implementations, a difference between MA results of different windows sizes can be determined. For example, operation S2 is a procedure for determining whether a difference in the MA for an input size of 10 and the MA for an input size of 2 exceeds a threshold (i.e., YES in operation S2), and operation S3 is a procedure for comparing the MA for the input size of 10 and the MA for the input size of 1. If the difference in MA results of different input sizes in S2 and/or S3 is large, then in some implementations, the gradient of lateral velocity can be further determined and compared with a threshold, as in operation S4. If the gradient of the lateral velocity exceeds the threshold, then the target can be classified as a moving-2 case, and otherwise can be classified as a moving-1 case.

Based on the result of process 600, the rate of updating the track can be varied, e.g., by updating the track more slowly or more quickly. For example, the rate of updating the track can be adjusted by changing the weights assigned to different MA results in the weighted average. For example, in FIG. 8, if the lateral position is slowly changing, e.g., if the track is deemed “stable,” then the rate of updating the track can be slower, e.g., by assigning more weight to larger-input MA results and less weight to smaller-input MA results. By contrast, if the lateral position is quickly changing, e.g., “moving-1” or “moving-2” tracks, the rate of updating the track can be faster, e.g., by assigning less weight to larger-input MA results, and more weight to smaller-input MA results. Further, comparing the moving-1 case and the moving-2 case in FIG. 8, the track lateral change rate of moving-2 case is greater than that of moving-1 case. In this case, the weights can be further differentiated between the moving-1 case and moving-2 case, for example by assigning proportionally greater weight to small-input MA results for the moving-2 case to better capture the quickly changing local movements.

FIG. 9 is a diagram illustrating an example 700 of the physical meaning of a difference in the input size of a moving average in a process of correcting a horizontal position error based on a moving average according to an implementation of the present disclosure.

As illustrated in FIG. 9, (a) shows the point information as measured by a sensor, e.g., a radar sensor, over time and (b) shows different MA graphs for different MA input sizes (i.e., different number of points that are input for different MA results). Thereafter, in (c), a weighted multiple MA operation is executed, where the different MA results in (b) are weighted and averaged (e.g., with different weights), and the weighted multiple moving average is calculated as shown in (d).

As shown in this example, as the MA input size increases, the resulting average reflects a more graph-global position update value and is less affected by local disturbances. To the contrary, when the MA input size is small, the resulting average reflects local position update values, and is greatly affected by local disturbances, and as a result, it is possible to respond quickly to changes.

Referring back again to FIG. 3, in operation S20, a track position is generated based on the weighted multiple moving average, and in operation S30, a horizontal velocity is recalculated and generated based on the estimated path. In this case, the horizontal velocity can be estimated by calculating the horizontal velocity using the position displacement of the object.

In operation S40, the velocity vector of the current object is extracted using the vertical velocity and the horizontal velocity, and the heading angle of the track is calculated using the velocity vector to generate corrected information.

In operation S50, when all track information is updated, the velocity and position are finally corrected by passing it through a two-dimensional Kalman filter, thereby completing the object tracking logic. For example, in the Kalman filtering update step of S50, the updated track information can be used, in conjunction with the previous tracking result (e.g., which can be used to obtain a prediction of the current track), to obtain an updated estimate of the tracking result at the current time point.

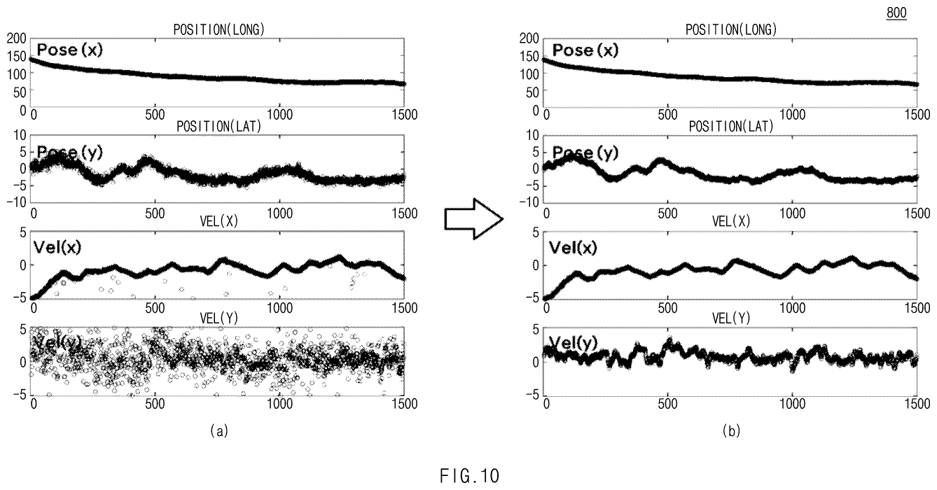

FIG. 10 is a diagram illustrating an example experimental result 800 to which a process for correcting a horizontal position error based on a moving average is applied according to an implementation of the present disclosure.

According to implementations of the present disclosure, stable position estimation is possible through processing logic, e.g., using a 3-step approach described earlier, that stabilizes the position of an object whose shape observation results are unstable. For example, in the case of cluster information as illustrated in (a) of FIG. 10, the lateral position and velocity are very unstable, but as illustrated in (b), by utilizing the technique according to implementations of the present disclosure, disturbance is reduced and stable tracking is possible.

As shown in FIG. 10, implementations of the present disclosure can provide a tracking technique that generates stable tracking results from observation results with very unstable shapes. Unlike LiDAR sensors, which provide point data reflected from the outline of an object, radar sensors can have unspecified reflection locations that may not accurately match the outline of an object. Therefore, when extracting the shape of an object using radar data obtained in such a manner, there is a high possibility that it is different from the shape information of an actual object, and there is also a large positional error in the shape actually extracted. According to implementations of the present disclosure, vertical velocity and position estimates can be updated using observed values according to a tracking technique that processes radar sensor input providing velocity information and shape information, while horizontal velocity and position are calculated using a new scheme. In this case, the confidence of the vertical velocity can be raised above a certain level to produce improved results. For example, according to implementations of the present disclosure, a new correction technique using a different moving average values with inputs of various sizes can be used when updating the horizontal position, thereby enabling stable position estimation. As such, implementations of the present disclosure can be used in cases where the detected shape of objects is very unstable, and is applicable to all systems that utilize tracking techniques, not limited to those using sensors. However, for sensors for which velocity observation results do not exist, additional processing may be used to correct the accuracy.

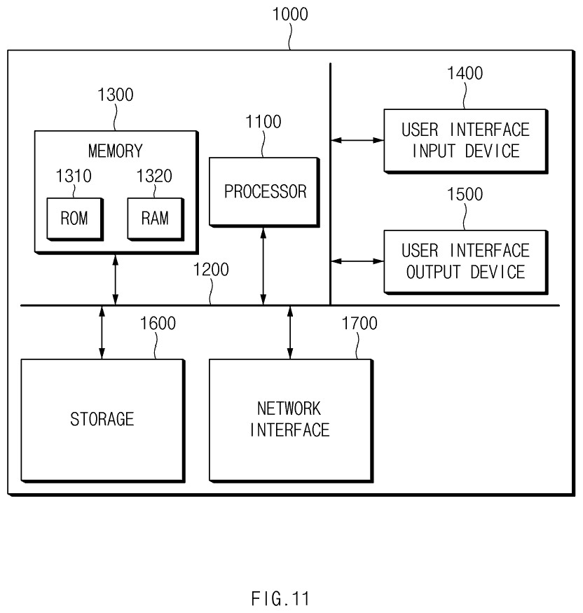

FIG. 11 is a block diagram illustrating a computing system 1000 for autonomous vehicle control and object recognition operations according to an implementation of the present disclosure.

Referring to FIG. 11, the computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described in relation to the implementations of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The present disclosure proposes a technology capable of stably estimating a position and correcting a velocity even when the shape of a radar observation object is unstable.

Although exemplary implementations of the present disclosure have been described for illustrative purposes, those skilled in the art will appreciate that various modifications, additions and substitutions are possible, without departing from the scope and spirit of the disclosure.

Therefore, the exemplary implementations disclosed in the present disclosure are provided for the sake of descriptions, not limiting the technical concepts of the present disclosure, and it should be understood that such exemplary implementations are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A system comprising:
at least one autonomous driving sensor comprising at least one radar sensor;
at least one processor; and
at least one memory storing computer program instructions that, based on being executed by the at least one processor, perform artificial intelligence (AI)-based operations of recognizing and estimating a position of an object in a surrounding environment based on detection point data obtained from the at least one radar sensor, the operations comprising:
performing preprocessing on the detection point data obtained from the at least one radar sensor, to generate preprocessed data;
performing clustering on the preprocessed data to generate at least one cluster of points;
generating cluster information from the at least one cluster of points, wherein the cluster information comprises position information and a velocity vector;
generating a prediction of a track that has been updated up to a previous time;
performing association between the cluster information and the prediction of the track that has been updated up to the previous time; and
generating an updated estimate of the track for a current time, based on the cluster information and the prediction of the track that has been updated up to the previous time,
wherein generating the updated estimate of the track comprises:
generating updated horizontal position information by applying a moving average to horizontal position information among the position information in the cluster information; and
updating track information, which includes heading information of the track, by recalculating a horizontal velocity of the velocity vector based on the position information including the updated horizontal position information.

2. The system of claim 1, wherein the generating of the updated estimate of the track further comprises generating updated position information and an updated velocity vector by applying a two-dimensional Kalman filter to the position information and the velocity vector after updating all of the track information.

3. The system of claim 1, wherein the generating of the updated estimate of the track further comprises using a vertical velocity of the velocity vector without updates.

4. The system of claim 3, wherein the generating of the updated estimate of the track further comprises updating vertical position information of the position information, based on the vertical velocity obtained through the at least one radar sensor.

5. The system of claim 1, wherein the applying of the moving average to the horizontal position information comprises:
based on a determination that a number of measurements accumulated by the radar sensor is equal to or greater than a threshold value, generating a plurality of moving average values based on radar sensor measurement results, wherein the plurality of moving average values are generated by applying a plurality of moving averages whose input sizes are different from each other.

6. The system of claim 5, wherein the applying of the moving average to the horizontal position information comprises:
generating a plurality of weighted moving averages by applying different weights to each of the plurality of moving average values according to a change rate of the track.

7. The system of claim 6, wherein the generating of the plurality of weighted moving averages comprises:
based on a determination that the change rate of the track is equal to or less than a reference value, assigning larger weights to moving average values generated by moving averages with larger input sizes and assigning smaller weights to moving average values generated by moving averages with smaller input sizes.

8. The system of claim 6, wherein the generating of the plurality of weighted moving averages comprises:
based on a determination that the change rate of the track exceeds a reference value, assigning smaller weights to moving average values generated by moving averages with larger input sizes and assigning larger weights to moving average values generated by moving averages with smaller input sizes.

9. The system of claim 6, wherein the change rate of the track includes a numerical value representing a speed of at which a target object tracked by the at least one radar sensor moves in a horizontal direction.

10. The system of claim 6, wherein, based on a determination that a number of the plurality of moving average values is less than a specified number, the object is considered not to be tracked by the at least one radar sensor.

11. An artificial intelligence (AI)-based method of recognizing and estimating a position of an object in a surrounding environment based on detection point data obtained from at least one autonomous driving sensor including at least one radar sensor, the method comprising:
performing preprocessing on the detection point data obtained from the at least one radar sensor, to generate preprocessed data;
performing clustering on the preprocessed data to generate at least one cluster of points;
generating cluster information from the at least one cluster of points, wherein the cluster information comprises position information and a velocity vector;
generating a prediction of a track that has been updated up to a previous time;
performing association between the cluster information and the prediction of the track that has been updated up to the previous time; and
generating an updated estimate of the track for a current time, based on the cluster information and the prediction of the track that has been updated up to the previous time,
wherein generating the updated estimate of the track comprises:
generating updated horizontal position information by applying a moving average to horizontal position information among the position information in the cluster information; and
updating track information, which includes heading information of the track, by recalculating a horizontal velocity of the velocity vector based on the position information including the updated horizontal position information.

12. The method of claim 11, wherein the generating of the updated estimate of the track further comprises:
generating updated position information and an updated velocity vector by applying a two-dimensional Kalman filter to the position information and the velocity vector after updating all of the track information.

13. The method of claim 11, wherein the generating of the updated estimate of the track further comprises using a vertical velocity of the velocity vector without updates.

14. The method of claim 13, wherein the generating of the updated estimate of the track further comprises updating vertical position information of the position information, based on the vertical velocity obtained through the at least one radar sensor.

15. The method of claim 11, wherein the applying of the moving average to the horizontal position information comprises:
based on a determination that a number of measurements accumulated by the radar sensor is equal to or greater than a threshold value, generating a plurality of moving average values based on radar sensor measurement results, wherein the plurality of moving average values are generated by applying a plurality of moving averages whose input sizes are different from each other.

16. The method of claim 15, wherein the applying of the moving average to the horizontal position information comprises:
generating a plurality of weighted moving averages by applying different weights to each of the plurality of moving average values according to a change rate of the track.

17. The method of claim 16, wherein the generating of the plurality of weighted moving averages comprises:
based on a determination that the change rate of the track is equal to or less than a reference value, assigning larger weights to moving average values generated by moving averages with larger input sizes and assigning smaller weights to moving average values generated by moving averages with smaller input sizes.

18. The method of claim 16, wherein the generating of the plurality of weighted moving averages comprises:
based on a determination that the change rate of the track exceeds a reference value, assigning smaller weights to moving average values generated by moving averages with larger input sizes and assigning larger weights to moving average values generated by moving averages with smaller input sizes.

19. The method of claim 16, wherein the change rate of the track includes a numerical value representing a speed of at which a target object tracked by the at least one radar sensor moves in a horizontal direction.

20. The method of claim 16, wherein, based on a determination that a number of the plurality of moving average values is less than a specified number, the object is considered not to be tracked by the at least one radar sensor.
